(19) United States
(12) Patent Application Publication
(10) Pub. No.: US 2002/0142674 A1
(43) Pub. Date: Oct. 3, 2002

(54) Electrical wedge connector having a wedge with an outer conductor support movably connected to an intermediate member

(76) Inventors: Richard Chadbourne, Merrimack, NH (US); Armand T. Montminy, Manchester, NH (US); William J. Lasko, Littleton, NH (US)

Correspondence Address: PERMAN & GREEN, 425 POST ROAD, FAIRFIELD, CT, 06430, US

(21) Appl. No.: 09/818,462

(22) Filed: Mar. 27, 2001

(51) Int. Cl. H01R 4/50

(52) U.S. Cl. 439/783

(57) ABSTRACT

An electrical wedge connector intermediate member comprising a main section and at least one connecting section. The main section has conductor contact surfaces on opposite sides of the main section. The at least one connecting section is adapted to connect a separate outer conductor support to the main section. A conductor can be clamped between one of the conductor contact surfaces of the main section and the outer conductor support connected to the at least one connecting section.

### BACKGROUND OF THE INVENTION

1. Field of the Invention

The present invention relates to electrical connectors and, more particularly, to an electrical wedge connector.

2. Prior Art

U.S. Pat. No. 5,911,604 discloses an electrical wedge connector having a wedge intermediate member and cushions which are located between the conductors and the wedge connector shell. U.S. Pat. No. 5,944,565 discloses an electrical wedge connector having a wedge with integral flaps. The electrical conductors are received between the flaps and conductor contact surfaces on a main body of the wedge.

### SUMMARY OF THE INVENTION

In accordance with one embodiment of the present invention, an electrical wedge connector intermediate member is provided comprising a main section and at least one connecting section. The main section has conductor contact surfaces on opposite sides of the main section. The at least one connecting section is adapted to connect a separate outer conductor support to the main section. A conductor can be clamped between one of the conductor contact surfaces of the main section and the outer conductor support connected to the at least one connecting section.

In accordance with another embodiment of the present invention, an electrical wedge connector is provided comprising a shell; and an intermediate assembly adapted to be inserted into the shell to electrically and mechanically connect at least two conductors to each other. The intermediate assembly comprises an intermediate member and at least one outer conductor support slidably connected to the intermediate member.

### BRIEF DESCRIPTION OF THE DRAWINGS

The foregoing aspects and other features of the present invention are explained in the following description, taken in connection with the accompanying drawings, wherein:

FIG. 1 is an exploded perspective view of an electrical wedge connector incorporating features of the present invention;

FIG. 2 is a rear end elevational view of the wedge connector shown in FIG. 1 shown connected to the two conductors;

FIG. 3 is an enlarged partial cross-sectional view of a portion of the connector shown in FIG. 1;

FIG. 4 is an exploded perspective view of an alternate embodiment of an electrical wedge connector incorporating features of the present invention;

FIG. 5 is a perspective view of the connector shown in FIG. 1 in an assembled condition;

FIG. 6 is a side elevational view of the wedge shown in FIG. 4;

FIG. 7 is an exploded perspective view of an alternate embodiment of an electrical wedge connector incorporating features of the present invention; and

FIG. 8 is a rear end elevational view of an alternate embodiment of the connector shown connected to two conductors.

### DETAILED DESCRIPTION OF THE PREFERRED EMBODIMENT

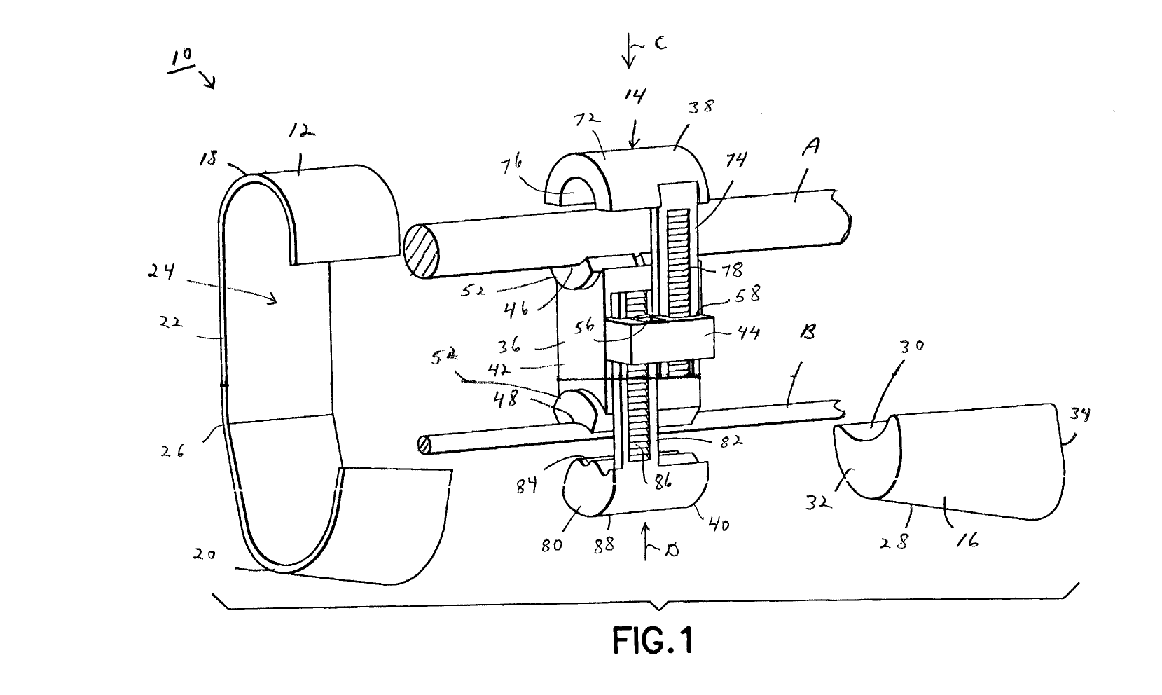

Referring to FIG. 1, there is shown an exploded perspective view of an electrical wedge connector 10 incorporating features of the present invention and portions of two electrical conductors A, B. Although the present invention will be described with reference to the embodiments shown in the drawings, it should be understood that the present invention can be embodied in many alternate forms of embodiments. In addition, any suitable size, shape or type of elements or materials could be used.

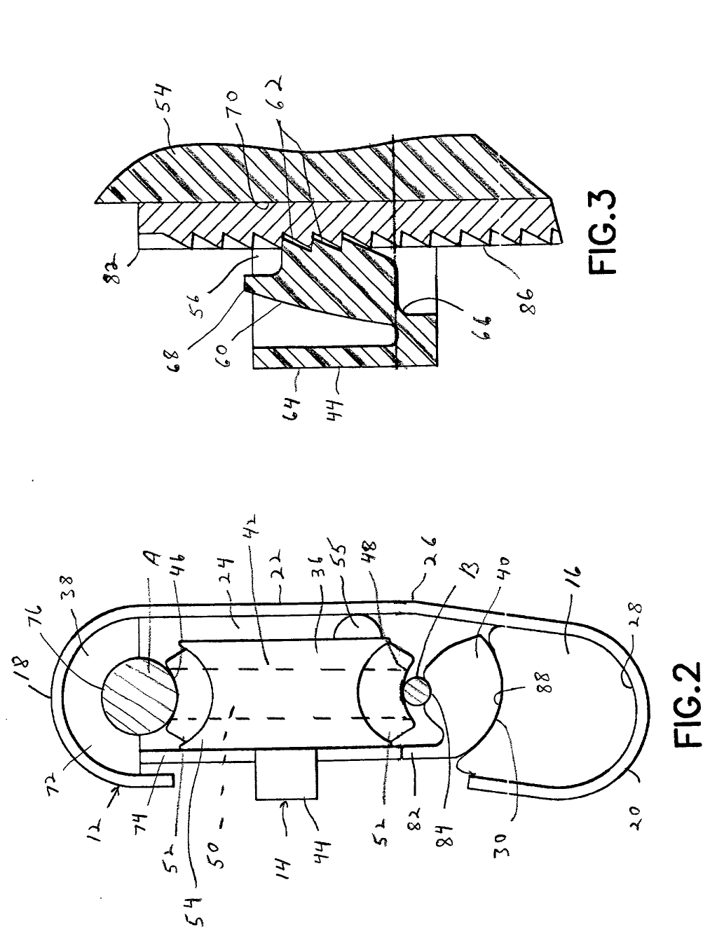

The connector 10 generally comprises a shell or sleeve 12, an intermediate assembly 14 and a wedge 16. However, in alternate embodiments additional components could be provided. The shell 12 is preferably comprised of metal, but any suitable material(s) could be used. Referring also to FIG. 2, in this embodiment the shell 12 comprises a general “C” shaped profile with two curved ends 18, 20 connected by a side 22 and forming a wedge shaped receiving area 24. The curved ends 18, 20 are angled relative to each other from rear to front to form the general wedge shaped receiving area 24. In this embodiment the side 22 has an angle 26 to angle the end 20 relative to the end 18 as shown best in FIG. 2.

However, in alternate embodiments the shell 12 could have any suitable shape.

The wedge 16 is a one-piece member generally comprised of metal. However, in alternate embodiments the wedge 16 could be comprised of multiple members and could be comprised of any suitable material(s). In the embodiment shown, the wedge 16 comprises an outer curved side 28, an inner curved side 30, and has a general wedge shaped side profile between its front end 32 and its rear end 34. However, in alternate embodiments the wedge 16 could have any suitable shape.

The intermediate assembly 14 generally comprises an intermediate member 36 and two outer conductor supports 38, 40. The intermediate member 36 generally comprises a main section 42 and a connecting section 44. The main section 42 includes two conductor contact surfaces 46, 48 located on opposite sides of the main section 42. In this embodiment the conductor contact surfaces 46, 48 are substantially parallel to each other. However, in alternate embodiments they could be angled relative to each other. The main section could include insulation piercing members 50 and seals 52 such as described in U.S. Pat. Nos. 5,911,604; 5,944,565; 5,842,893; 6,068,525; 5,916,001; and 5,944,564 and U.S. patent application Ser. Nos. 08/990,996; 09/596,508 and 09/605,914 which are hereby incorporated by reference in their entireties. Alternatively, the insulation piercing members could be integrally formed with the rest of the main section. In an alternate embodiment the insulation piercing members and/or seals might not be provided. In the embodiment shown the main section 42 has a housing 54 made of a suitable material, such as molded plastic.

However, any suitable material(s) could be used. The connecting section 44 could be integrally molded with the housing 54 or mechanically attached to the housing 54.

Referring also to FIG. 3, in this embodiment the connecting section 44 is located on only one lateral side of the housing 54, but could be located on more than one side. In this embodiment the housing 54 also comprises a positioning standoff 55. However, in alternate embodiments a standoff might not be provided. In this embodiment the connection section 44 has two apertures 56, 58. However, in alternate embodiments more or less apertures could be provided. Located in each aperture is a lock 60. In the embodiment shown each lock 60 comprises a movable ratcheting latch. However, in alternate embodiments any suitable type of lock could be provided. Each latch 60 has ratcheting teeth 62 and is movably attached to an outer section 64 by a living hinge 66. However, in alternate embodiments any suitable movable connection of the latch 60 could be provided and any suitable latching or retaining surface could be provided. The living hinge 66 biases the latch 60 towards the lateral side 70 of the housing 54. However, any suitable biasing system could be provided. The latch 60 also has a finger contact section 68. The finger contact section 68 allows a user to directly manually move the latch to an unlatched position. However, in alternate embodiments the finger contact section might not be provided or any suitable unlatching system could be provided. The latches 60 in each of the two apertures 56, 58 are reversely oriented relative to each other. The latch 60 in the aperture 56 has its living hinge orientated proximate the bottom of the aperture 56 and the latch 60 in the aperture 58 has its living hinge orientated proximate the top of the aperture with the orientations of the teeth 62 in each aperture 56, 58 being reverse to each other.

The upper outer conductor support 38 generally comprises an end section 72 and a leg section 74. The end section 72 has a conductor contact surface 76 located opposite the surface 46. The leg section 74 extends from a lateral side of the end section 72. In an alternate embodiment the upper outer conductor support 38 could comprise multiple leg sections and/or could be comprised of multiple members; each having an end section and a leg section(s). The leg section 74 has a ratcheting teeth surface 78 therealong. The leg section 74 extends into and through the aperture 58 in the connecting section 44. The latch 60 in the aperture 58 has its teeth 62 biased against the ratcheting teeth surface 78. A user can move the upper outer conductor support 38 as indicated by arrow C to move the surface 76 towards the surface 46 with the surface 78 riding along the teeth 62, but the interaction between the teeth 62 and the ratcheting teeth surface 78 prevent movement of the support 38 in a direction opposite to direction C; except when latch 60 is directly manually moved to an unlatched position by a user. The leg section 74 is, thus, able to slide along and through the aperture 58. The support 38 can be manually moved by a user to clamp the conductor A between the two surfaces 76, 46 before installation of the assembly 14 into the shell 12. This retains the assembly 14 with the conductor A and allows the assembly 14 to be laterally mounted on the conductor A.

The lower outer conductor support 40 generally comprises an end section 80 and a leg section 82. The end section 80, in this embodiment, is different from the end section 72, but in alternate embodiments they could be the same. The end section 80 has a conductor contact surface 84 located opposite the surface 48. The leg section 82 extends from a lateral side of the end section 80. In an alternate embodiment the lower outer conductor support 40 could comprise multiple leg sections and/or could be comprised of multiple members; each having an end section and a leg section(s). The leg section 82 has a ratcheting teeth surface 86 therealong. The leg section 82 extends into and through the aperture 56 in the connecting section 44. The latch 60 in the aperture 56 has its teeth 62 biased against the ratcheting teeth surface 86. A user can move the lower outer conductor support 40 as indicated by arrow D to move the surface 84 towards the surface 48 with the surface 86 riding along the teeth 62, but the ratcheting teeth surface 86 prevent movement of the support 40 in a direction opposite to direction D; except when latch 60 is directly manually moved to an unlatched position by a user. The leg section 82 is, thus, able to slide along and through the aperture 56. The support 40 can be manually moved by a user to clamp the conductor between the two surfaces 84, 48 before installation of the assembly 14 into the shell 12. This retains the assembly 14 with the conductor B and allows the assembly 14 to be laterally mounted on the conductor B. Thus, the assembly 14 can be hand assembled in an at least temporary retaining fashion with the two conductors A, B, before insertion into the shell 12.

In the embodiment shown the surface 30 of the wedge 16 and the surface 88 of the lower outer conductor support 40 are substantially the same, but could be slightly different. After assembly of the assembly 14 with the conductors A, B, they are inserted into the receiving area 24 of the shell 12. The user can insert the wedge 16 in the receiving area 24 with the surface 28 against the curved end 20 and the two surfaces 30, 88 contacting each other. Further insertion of the wedge 16, such as by use of a tool, wedges the assembly 14 against the top end 18 of the shell 12. The shell 12 can deflect at angle 26 to straighten, at least partially, and spring load the assembly 14 and wedge 16 against each other. At the same time, the outer conductor supports 38, 40 can exert additional force against the conductors A, B to fixedly clamp the conductors in the assembly 14 and also pierce through conductor insulation when the assembly 14 has insulation piercing members 50 or equivalent.

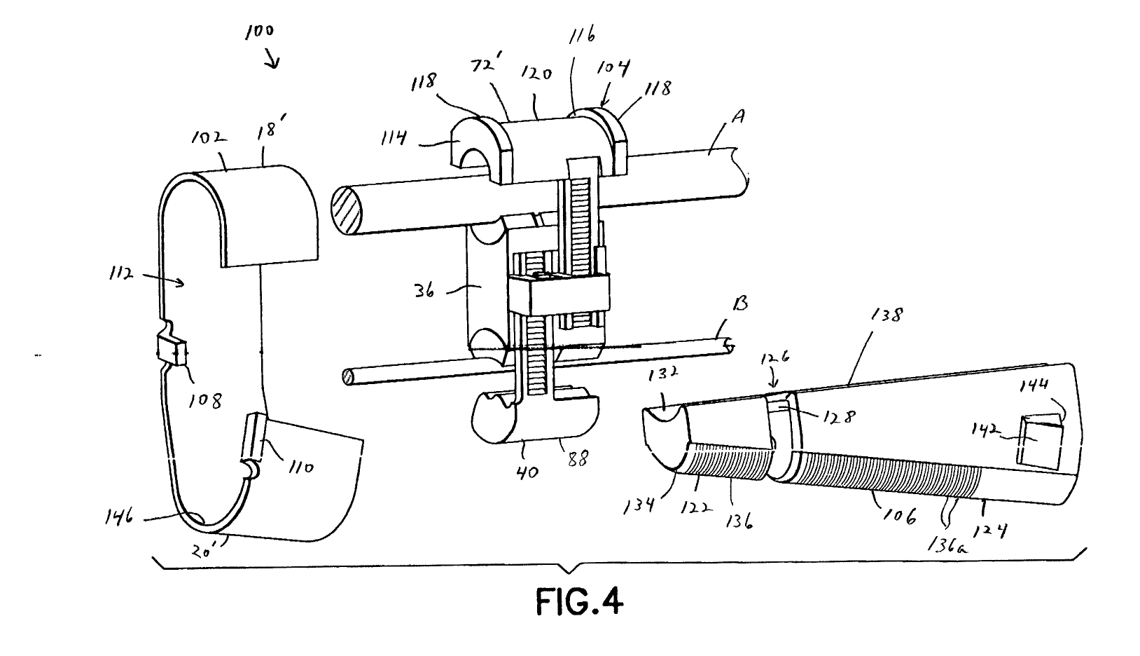

Referring now to FIGS. 4-6 an alternate embodiment will be described, in this embodiment the connector 100 generally comprises a shell 102, an intermediate assembly 104, and a wedge 106. The shell 102 is similar to the shell 12, but does not include the angle 26 and includes feature 108, 110 at the front end of the shell. The features 108 projects across the front of the receiving area 112. The feature 110 projects laterally outward. The shell 102 is preferably comprised of a one-piece sheet metal member with the projection features 108, 110 being stamped and formed. However, any suitable process could be used to form the shell and the features 108, 110 could have any suitable shape or configuration.

The intermediate assembly 104 generally comprises the intermediate member 36, the lower outer conductor support 40, and an upper outer conductor support 114. In this embodiment the upper support 114 is substantially the same as the support 38, but includes a shell latch 116.

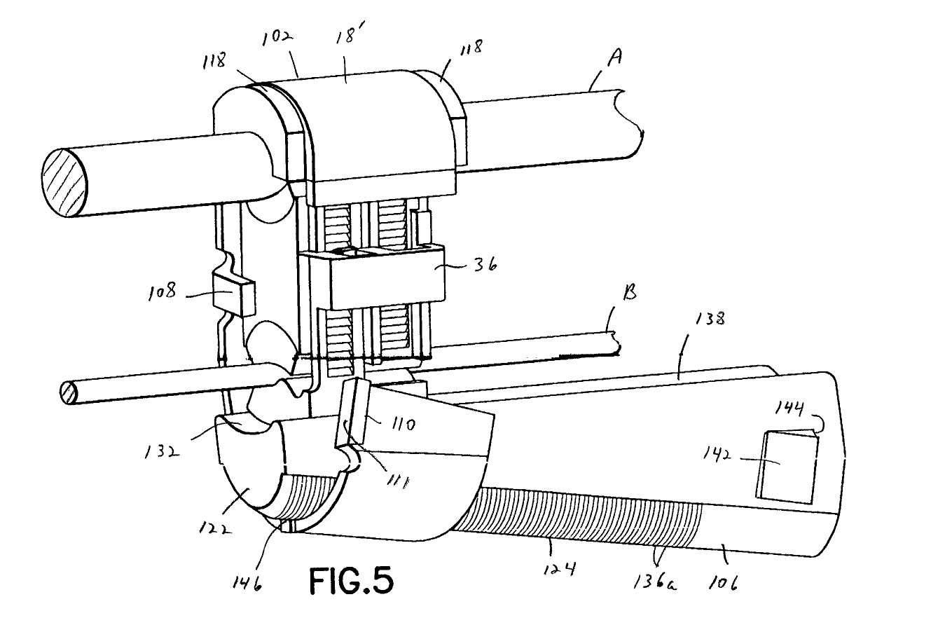

The shell latch 116 includes two outward projections 118 on opposite ends of the end section 72′ which form a recess 120 at the outer surface of the end section 72′. As seen in FIG. 5, the recess 120 is suitably sized to receive the top end 18′ of the shell 102 therein such that the front and rear ends of the top end 18′ are retained in the recess 120 between the projections 118. The front projection feature 108 can contact the front of the intermediate member 36 to retain the assembly 104 in receiving area 112 and prevent the assembly from being pushed out the front end of the shell. However, any suitable stop, limiter or positioner(s) could be provided between the shell and the intermediate assembly.

The wedge 106 generally comprises a front section 122, a rear section 124 and a break-away section 126 between the front and rear sections. However, in alternate embodiments any suitable type or shape of wedge(s) could be provided. The break-away section 126 generally comprises a first breakage section 128 fixedly connecting the front and rear sections 122, 124 to each other, and a second breakage section 130. The first breakage section 128 has two spaced rod sections (only one of which is shown) adapted to be cut by a tool, such as pliers. The second breakage section 130 is a twist-breaking section. After the first breakage section is cut, the user can axially twist the front and rear section 122, 124 relative to each other to cause the section 130 to break. The front section 122 can, thus, be removed from the rear section 124.

The front section 122 generally comprises a wedge shaped member with a top curved assembly contact surface 132 and a generally curved bottom surface 134. The bottom surface 134 also comprises gripping features 136 for ratchet-type gripping with the shell 102.

The rear section 124 generally comprises a wedge shaped member with a top curved assembly contact surface 138 and a generally curved bottom surface 140. The bottom surface 140 also has gripping features 136. A lateral side of the rear section 124 also comprises a projection or protrusion 142 with a rear surface 144. In an alternate embodiment, the protrusion 142 could be replaced by a recess into the lateral side of the rear section 124. The recess could form a surface for a tool to press the rear section 124 forward.

With particular reference to FIG. 5, when the wedge 106 is inserted into the shell 102, the assembly 104 is preferably already in place in the shell. The surfaces 132, 138 can contact and slide along the surface 88 of the lower outer conductor support 40. The surfaces 134, 140 can contact and slide along the inside surface of the lower curved end 20′ of the shell 102. The gripping features 136 can grip in front of the edge 146 of the shell 102 to prevent unintentional withdrawal of the wedge 106 from the shell.

In this embodiment the projection feature 110 and the projection 142 are provided to assist in final installation of the wedge 106 into the shell 102. However, in alternate embodiments the projections 110, 142 might not be provided. Once assembled as shown in FIG. 5, a user can use a tool, such as a pair of pliers, which is placed against surfaces 111 and 144 and compresses the two surfaces towards each other. This drives the wedge 106 fully into the sleeve 102. Because of the interlock of the latch 116 with the shell 102, the interlock of the gripping features 136 with the shell, and the spring biasing of the shell ends 18′, 20′ against the assembly 104 and the wedge 106, the connector 100 is fixedly assembled and the conductors A, B are fixedly held in the connector.

One of the features of the wedge 106 is the break-away section 128. The size of the conductors A, B can vary. For smaller size conductors, the wedge 106 might need to be inserted into the shell 102 almost completely; such as rear gripping features 136a contacting the front gripping edge 146 of the shell. In this situation, the user can break off the front section 122 from the rear section 124 at the break-away section 126. This can reduce the weight of the connector 100 for small size conductors. The rear section 124 might also be removed and not used for large size conductors.

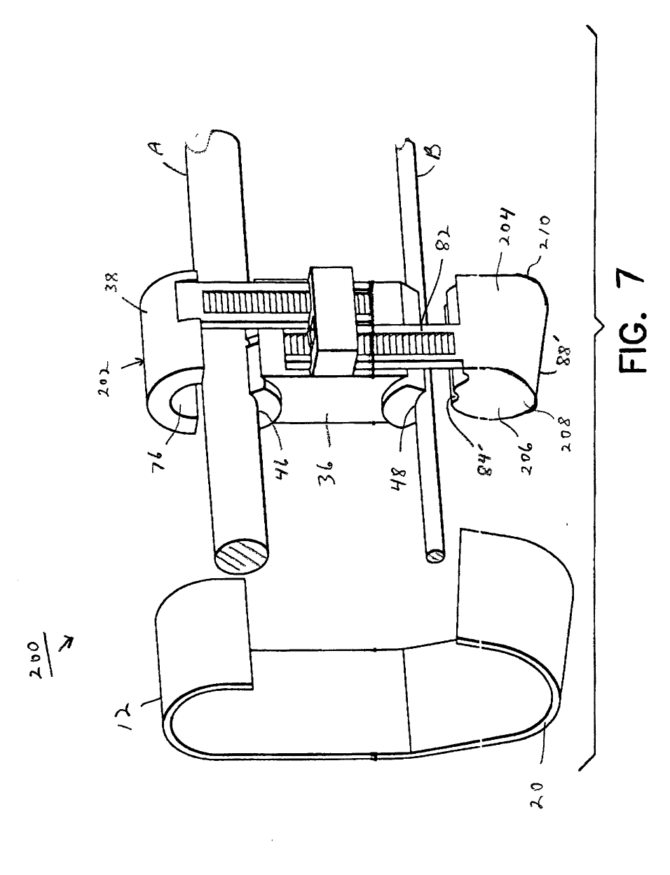

Referring now to FIG. 7 another alternate embodiment of the present invention is shown. In this embodiment the connector 200 generally comprises the shell 12 and the intermediate assembly 202. The intermediate assembly 202 generally comprises the intermediate member 36, the upper outer conductor support 38, and a lower outer conductor support 204. The lower support 204 generally comprises an end section 206 and the leg section 82. The end section 206 generally comprises a conductor contact surface 84′ and an outer curved surface 88′. The end section 206 increases in height from the front end 208 to the back end 210. Thus, the height of the end section 206 has a general wedge shape.

When the assembly 202 is inserted into the shell 12, the surface 88′ contacts the inner surface of the end 20 and is wedged towards the intermediate member 36. This embodiment does away with use of an additional wedge. This could be used for even larger conductors or smaller size shells. The surfaces 46 and 76, and 84′ and 48 still move towards each other in parallel. This can reduce or minimize damage to insulation on the conductors A, B. In an alternate embodiment the upper support 38 could have a wedge shaped end section. The surfaces 76, 46 and 48, 84 are preferably parallel to the direction of insertion of the assembly 202 into the shell. However, in alternate embodiments, the center axes between the surfaces 46, 76 and 48, 84 could be angled relative to direction of insertion so long as the movement of the surfaces 46 and 76 are preferably parallel to each other and the movement of the surfaces 48 and 84 are preferably parallel to each other.

With the present invention various different components can be interchanged or intermixed to configure a connector for the type and size of conductors intended to be connected. For example, intermediate member 36 is usable in multiple different embodiments as shown in FIGS. 1, 4 and 7, supports 38 and 114 can be interchanged and supports 40 and 204 can be interchanged. Of course, in alternate embodiments other types of intermediate members and/or other supports could be provided and interchanged to form a desired intermediate assembly.

Referring now to FIG. 8 an end elevational view of another alternate embodiment is shown. In this embodiment the connector 300 generally comprises a shell 302, an intermediate assembly 304 and a wedge 16. The shell 302 is substantially identical to the shell 12, but includes a lateral side projection 306 in sidewall 22′ which forms a recess 308.

The intermediate assembly 304 generally comprises an intermediate member 310 and two outer conductor supports 312, 314. The intermediate member 310 is substantially identical to the intermediate member 36, but includes a first connecting section 44′ and a second connecting section 44″. The first connecting section 44′ is substantially identical to the connecting section 44 described with reference to FIG. 1 above. The second connecting section 44″ is substantially a mirror image of the first connecting section 44′. However, in alternate embodiments more than two connecting sections could be provided and/or they could have substantially different configurations from each other. The recess 308 in the shell 302 is suitably sized and shaped to allow the second connecting section 44″ to fit therein.

In this embodiment the upper support 312 has an end section 72′ and two leg sections 74′ and 74″. The two leg sections 74′, 74″ are received in respective ones of the connecting sections 44′ and 44″. Likewise, the lower support 314 has an end section 80′ and two leg sections 82′ and 82″. The two leg sections 82′, 82″ are received in respective ones of the connecting sections 44′ and 44′. In alternate embodiments the supports 312, 314 could have more or less than two leg sections each.

The present invention corresponds to an improved structure of cushioning elements which comprise mutual holding features in order to create a sub-assembly comprising the cables, a connecting element between the cables and two cushion elements surrounding part of the cables prior to insertion in the shell. The connecting element can be of the type that includes an insulating block provided with wire piercing and electrical connection blades. The cable receiving profiles in the blade housing can be parallel since an additional wedge element is added. However, keeping the holding features design it is possible to have a blade housing designed as a wedge in a design without the additional wedge, the additional wedge providing increased conductor size range taking capability.

The new design could also be used with a simple one wedge and cushion structure. The external wedge is not required to take advantage of the ratcheted holding structure. The external wedge provides additional independent advantages. One of which is standardizing of components to expand the product line for more conductor size range taking. Range taking is increased by replacing the external wedge component with another one accommodating a different fit condition. The other components would remain intact or be only slightly modified.

The FIG. 4 embodiment has a saddle configuration on the run cushion 114 to orient it properly with the C-frame. It is anticipated that there will be a desire to connect the run conductor to a tap of the same size (i.e.: 4 AWG service entrance). To do this it would be beneficial to use the same cushion component in both the run and tap positions. The current saddle provision would not be suitable for this. Thus, a provision added to the C-frame to engage the run cushion could be more suitable.

In a situation where an external wedge was not being used, a provision could be added to the C-frame to hold the wedge element (or other suitable part of the assembly). This would enable the installer to position the ratcheting wedge+cushions assembly on the conductors by hand then slip the C-frame over the assembly. The C-frame would slide over the cushions and latch to the wedge or other suitable part of the assembly.

As can be seen from the drawings, the preferred design comprises two sets of straps and ratchet on one side of the blade housing and cushions. However, designs with sets of straps on two sides of the blade housing or designs with additional straps are possible.

It is not mandatory to have the holding structure between the cushions on only one side. Each cushion could have at least one ratcheting strap engaging on each side of the blade housing. A recessed area would then be required in the web of the C-frame to receive the additional structure on the C-frame side (see FIG. 8).

The structure could be completely symmetrical about the vertical centerline between the conductor grooves with one strap on each side of the blade housing; or the straps could be located diagonally offset with one on each side of the blade housing. The corresponding mating structure would also be required on the blade housing.

In a wider product version (with perhaps four blades) there could be more than two ratcheting straps per cushion. There could be two on each side of the blade housing (four per cushion) or two on one side and one on the other (three on each cushion) or other similar configurations.

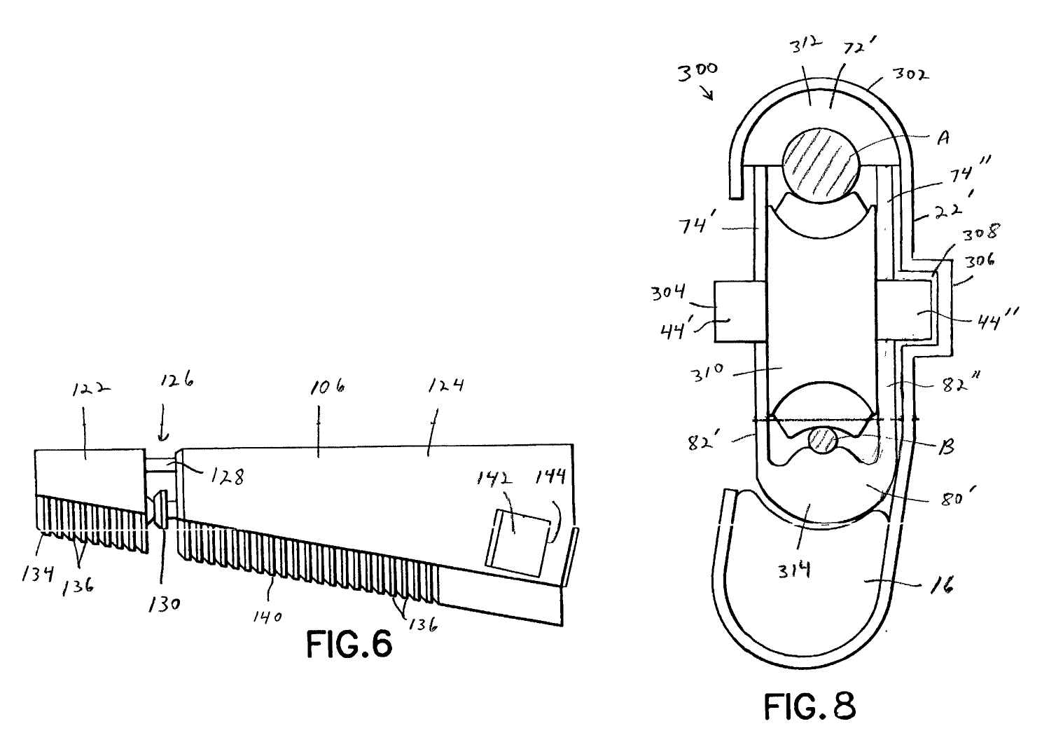

The additional wedge element when provided may also have a ratched structure and looking at FIG. 6, it is described that the additional wedge together with the C shell have protruding profiles allowing the use of a pair of pliers to drive the additional wedge inside the C shell in order to make the connection.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical wedge connector intermediate member comprising:
a main section having conductor contact surfaces on opposite sides of the main section;
at least one connecting section adapted to connect a separate outer conductor support to the main section, wherein a conductor can be clamped between one of the conductor contact surfaces of the main section and the outer conductor support connected to the at least one connecting section.

2. An intermediate member as in claim 1 wherein the at least one connecting section is adapted to movably connect the outer conductor support to the main section.

3. An intermediate member as in claim 2 wherein the at least one connecting section is adapted to slidably connect the outer conductor support to the main section.

4. An intermediate member as in claim 2 wherein the at least one connecting section comprises a lock for locking a relative position of the outer conductor support relative to the main section.

5. An intermediate member as in claim 4 wherein the lock comprises a movable ratcheting latch.

6. An intermediate member as in claim 2 wherein the at least one connecting section comprises an aperture for a portion of the outer conductor support to pass through the aperture.

7. An intermediate member as in claim 6 wherein the at least one connecting section comprises at least two of the apertures.

8. An intermediate member as in claim 6 wherein the at least one connecting section comprises a movable ratcheting latch at the aperture.

9. An intermediate member as in claim 1 wherein the intermediate member comprises at least two of the connecting sections, the two connecting sections being located on opposite sides of the main section.

10. An intermediate member as in claim 1 wherein the main section comprises a frame and contacts connected to the frame, the contacts extending into conductor receiving areas at the conductor contact surfaces.

11. An intermediate member as in claim 1 wherein the conductor contact surfaces of the main section are substantially parallel to each other.

12. An electrical wedge connector intermediate assembly comprising:
the electrical wedge connector intermediate member as recited in claim 1; and
a first outer conductor support connected to the connecting section of the intermediate member.

13. An intermediate assembly as in claim 12 wherein the first outer conductor support comprises a first end section located opposite one of the conductor contact surfaces of the main section and at least one first leg section slidably connected to the connecting section of the intermediate member.

14. An intermediate assembly as in claim 13 wherein the leg section comprises a ratcheting teeth surface.

15. An intermediate assembly as in claim 13 further comprising a second outer conductor support connected to the at least one connecting section of the intermediate member, the second outer conductor support comprising a second end section located opposite another one of the conductor contact surfaces and at least one second leg section slidably connected to the at least one connecting section.

16. An intermediate assembly as in claim 15 wherein at least one first leg section and at least one second leg section are connected to a same side of the intermediate member.

17. An intermediate assembly as in claim 12 wherein the first outer conductor support comprises a first end section having an inner conductor contact surface and a shell latch at an outer surface, the shell latch comprising two outward projections on opposite ends of the first end section.

18. An electrical wedge connector comprising:
a wedge connector shell;
an intermediate assembly as in claim 12; and
a wedge adapted to be inserted between the shell and the intermediate assembly.

19. An electrical wedge connector as in claim 18 wherein the shell and the wedge comprise protrusions for clamping the protrusions towards each other for moving the wedge into the shell.

20. An electrical wedge connector as in claim 18 wherein the wedge comprises a front section connected to a rear section by a break-away section.

21. An electrical wedge connector as in claim 20 wherein the break-away section comprises a first breakage section fixedly connecting the front and rear sections and the rear section having a second breakage section which is adapted to be axially twisted to break the front and rear sections apart.

22. An electrical wedge connector comprising:
a shell; and
an intermediate assembly adapted to be inserted into the shell to electrically and mechanically connect at least two conductors to each other, wherein the intermediate assembly comprises an intermediate member and at least one outer conductor support slidably connected to the intermediate member.
